(19) United States
(12) Patent Application Publication
(10) Pub. No.: US 2018/0321192 A1
(43) Pub. Date: Nov. 8, 2018

(54) NON-INVASIVE FLANGE INSPECTION

(71) Applicant: PINNACLEAIS INSPECTION L.L.C., Pasadena, TX (US)

(72) Inventor: Adam Gardner, Pasadena, TX (US)

(73) Assignee: PINNACLEAIS INSPECTION L.L.C., Pasadena, TX (US)

(21) Appl. No.: 15/973,328

(22) Filed: May 7, 2018

Related U.S. Application Data
(60) Provisional application No. 62/502,416, filed on May 5, 2017.

(51) Int. Cl. G01N 29/04; G01N 29/26; G01N 29/22

(52) U.S. Cl. CPC G01N 29/043; G01N 29/262; G01N 2291/105; G01N 2291/2698; G01N 2291/0289; G01N 29/226

(57) ABSTRACT

A non-invasive flange inspection system includes an ultrasonic scanning control unit and a probe with acoustic transducers coupled to the ultrasonic scanning control unit. The system also includes an output device that stores or displays ultrasonic scanning results, obtained using the ultrasonic scanning control unit and the probe on a flange in an assembled flange-to-flange pipe arrangement, for multiple radial distances along a hidden gasket sealing surface of the flange. A related method includes aligning an ultrasonic scanning probe with a flange in an assembled flange-to-flange pipe arrangement. The method also includes outputting control signals, by an ultrasonic scanning control unit, to the ultrasonic scanning probe to obtain ultrasonic scanning results for multiple radial distances along a hidden gasket sealing surface of the flange. The method also includes storing or displaying the ultrasonic scanning results for the multiple radial distances along the hidden gasket sealing surface of the flange.

### CROSS-REFERENCE TO RELATED APPLICATIONS

The present application claims priority to U.S. Provisional Application 62/502,416, filed May 5, 2017, entitled “Non-Invasive Flange Inspection”, and hereby incorporated herein by reference in its entirety.

### BACKGROUND

Hydrocarbons extracted from downhole formations generally need to be refined before they are distributed as an end-product. One example refining process is referred to as alkylation. During the alkylation process hydrocarbons are mixed with an acid such as hydrofluoric acid or sulphuric acid. Facilities that refine hydrocarbons may employ many source material units (e.g., to provide hydrocarbons or acids), process units to mix the source materials together, storage units to store the end-product, and connective pipes. As an example, a refinery may have hundreds to thousands of pipes that are interconnected using flanges. Over time, refinery components including pipes and flanges are subject to corrosion, servicing, and replacement. The customary inspection process for flanges involves disassembly of a flange-to-flange pipe arrangement and then visual inspection of the flange. The amount of time and cost to inspect and service refinery components is undesirably high.

### SUMMARY

Accordingly, there is provided herein novel non-invasive flange inspection systems and methods. In at least some embodiments, a non-invasive flange inspection system comprises an ultrasonic scanning control unit. The system also comprises a probe with acoustic transducers coupled to the ultrasonic scanning control unit. The system also comprises an output device that stores or displays ultrasonic scanning results, obtained using the ultrasonic scanning control unit and the probe on a flange in an assembled flange-to-flange pipe arrangement, for multiple radial distances along a hidden gasket sealing surface of the flange.

In at least some embodiments, a non-invasive flange inspection method comprises aligning an ultrasonic scanning probe with a flange in an assembled flange-to-flange pipe arrangement. The method also comprises outputting control signals, by an ultrasonic scanning control unit, to the ultrasonic scanning probe to obtain ultrasonic scanning results for multiple radial distances along a hidden gasket sealing surface of the flange. The method also comprises storing or displaying the ultrasonic scanning results for the multiple radial distances along the hidden gasket sealing surface of the flange.

Each of the foregoing embodiments may be implemented in combination and/or may include one or more of the following features in any combination: (a) a wedge is positioned between the probe and the flange while collecting ultrasonic scanning results; b) wherein the probe is a 10 MHz probe; c) the ultrasonic scanning control unit is programmed to perform beam steering at a plurality of angles without moving the probe to obtain the ultrasonic scanning results for multiple radial distances along the hidden gasket sealing surface of the flange; d) the probe angle relative to the hidden gasket sealing surface of the flange is adjusted manually to obtain the ultrasonic scanning results for multiple radial distances along the hidden gasket sealing surface of the flange; e) the ultrasonic scanning control unit, the probe, and the output device are part of a portable phased-array tool; f) the ultrasonic scanning results correspond to S-scans and related A-scans, wherein the S-scans and related A-scans are analyzed to identify a level of corrosion or tapering at different radial distances along a hidden gasket sealing surface of the flange; g) wherein a user manually analyzes displayed S-scans and related A-scans to identify a level of corrosion or tapering at different radial distances along the hidden gasket sealing surface of the flange; h) wherein a computer executes a program to automate analysis of the S-scans and related A-scans to identify a level of corrosion or tapering at different radial distances along the hidden gasket sealing surface of the flange; i) a computer with a processor and a computer-readable storage medium stores an inspection report program, wherein the inspection report program, when executed, is used to create an inspection report for the flange based on the ultrasonic scanning results for multiple radial distances along the hidden gasket sealing surface of the flange; j) wherein aligning an ultrasonic scanning probe with an assembled flange comprises positioning a wedge between the probe and the flange; k) the ultrasonic scanning results for multiple radial distances along the hidden gasket sealing surface of the flange are obtained by adjusting an angle of the probe relative to the hidden gasket sealing surface of the flange; l) the ultrasonic scan results for multiple radial distances along the hidden gasket sealing surface of the flange are obtained using beam steering without moving the probe; m) programming the ultrasonic scanning control unit to perform the beam steering at a plurality of angles relative to the hidden gasket sealing surface of the flange; n) wherein outputting control signals comprises directing transducers of a 10 MHz probe; o) performing the non-invasive flange inspection method for different areas around the flange to obtain a set of inspection points at different azimuths and radial distances along the hidden gasket sealing surface of the flange; p) analyzing S-scans and related A-scans, corresponding to the ultrasonic scanning results, to identify a level of corrosion or tapering at different radial distances along the hidden gasket sealing surface of the flange; q) using a portable phased-array tool to perform said outputting and said storing or displaying; r) using a computer with an inspection report program to create an inspection report for the flange based on the ultrasonic scanning results for multiple radial distances along the hidden gasket sealing surface of the flange.

### BRIEF DESCRIPTION OF THE DRAWINGS

In the drawings:

FIG. 1 is a schematic diagram of a known flange-to-flange pipe arrangement.

FIG. 2 is a cutaway diagram of an illustrative flange to which a non-invasive flange inspection can be applied.

FIG. 3 is a block diagram of an illustrative non-invasive flange inspection environment.

FIG. 4 is a block diagram and partial cross-sectional view of a non-invasive flange inspection scenario.

FIG. 5 is a block diagram of an illustrative ultrasonic probe.

FIG. 6 is a block diagram of an illustrative wedge for use with an ultrasonic probe.

FIG. 7 shows a perspective view of different ultrasonic scanning scenarios.

FIG. 8 shows a hidden gasket sealing surface and illustrative measurement points as a function of radial distance and azimuthal angle.

FIG. 9 shows an illustrative image corresponding to ultrasonic scanning results obtained to inspect a hidden gasket sealing surface.

FIG. 10 shows another illustrative image of ultrasonic scanning results related to inspection of a hidden gasket sealing surface.

FIG. 11 shows an illustrative flange inspection report.

FIG. 12 shows a flowchart of an illustrative non-invasive flange inspection method.

It should be understood that the drawings and corresponding detailed description do not limit the disclosure, but on the contrary, they provide the foundation for understanding all modifications, equivalents, and alternatives falling within the scope of the appended claims.

### TERMINOLOGY

In the following description, “flange” refers to a pipe flange that is added to the end of a pipe to facilitate connecting different pipe segments together (flange-to-flange). There are many different pipe flange standards, dimensions, materials, ratings, connection styles, and related gaskets. As used herein, a flange's “hidden gasket sealing surface” refers to at least one surface that contacts a gasket and is hidden when the flange is in an assembled condition (e.g., part of an assembled flange-to-flange pipe assembly).

### DETAILED DESCRIPTION

Disclosed herein are novel non-invasive flange inspection systems and methods. In accordance with at least some embodiments, the disclosed non-invasive flange inspection systems and methods involve ultrasonic scanning. For example, an illustrative ultrasonic scanning tool includes an ultrasonic scanning control unit and a probe with acoustic transducers coupled to the ultrasonic scanning control unit. In operation, the ultrasonic scanning control unit outputs control signals to the acoustic transducers of the probe resulting in different ultrasonic scanning options. In at least some embodiments, a wedge can be positioned between the probe and a flange being scanned to further vary the ultrasonic scanning options available. With proper programming of the ultrasonic scanning control unit, selection/adjustment of probe options (e.g., probe type and orientation), and/or selection/adjustment of wedge options (e.g., wedge type and orientation), ultrasonic scanning results can be obtained for multiple radial distances along a hidden gasket sealing surface of a flange. As desired, ultrasonic scanning can be performed for a flange such that ultrasonic scanning results corresponding to multiple radial distances and/or multiple azimuthal angles of a hidden gasket sealing surface are obtained. In this manner, the condition of the entire hidden gasket sealing surface is accurately revealed.

It should be understood that the number of ultrasonic scanning results used to identify the condition of the hidden gasket sealing surface of a flange can vary for different embodiments (e.g., the resolution of measurement points across the hidden gasket sealing surface can be increased or decreased according to different service provider or customer criteria). The same ultrasonic scanning process can be repeated for a plurality of assembled flanges in a refinery (or other facility), and a report is provided to a customer, where the condition of hidden gasket sealing surfaces of flanges can be known without disassembly. In some embodiments, inspected flanges can be flagged for subsequent disassembly and visual inspection based on the results of the non-invasive flange inspection technique described herein (e.g., inspected flanges can be identified as good, bad, or questionable). Also, an estimated lifetime or subsequent inspection schedule can be provided for flanges based on the non-invasive flange inspection technique described herein.

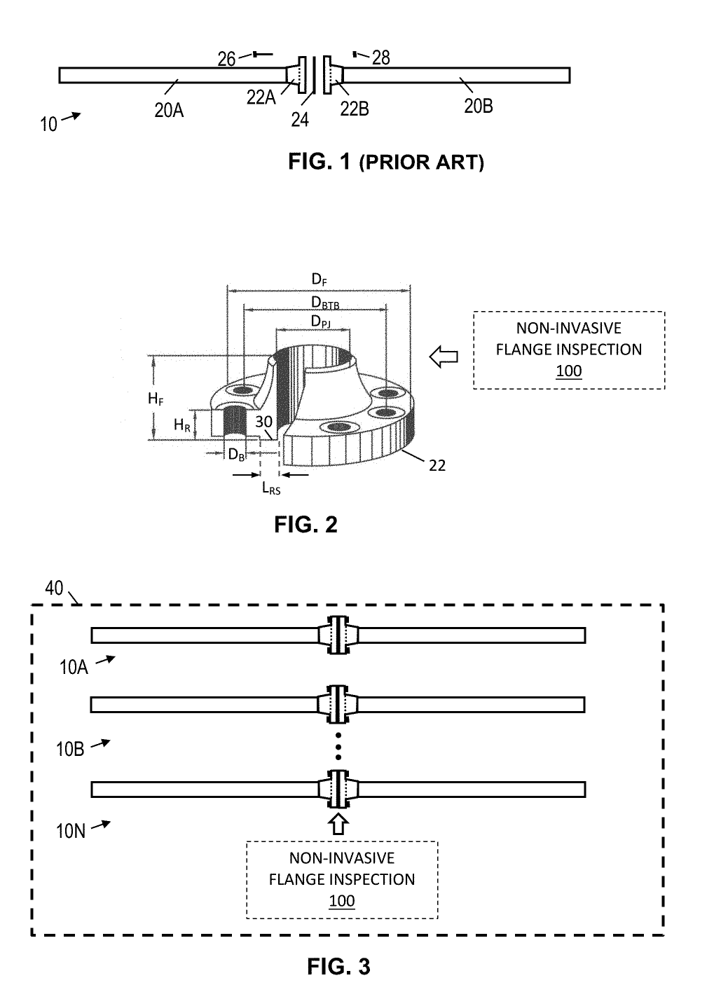

FIG. 1 is a schematic diagram of a known flange-to-flange pipe arrangement 10. As shown, the flange-to-flange pipe assembly 10 includes a first pipe 20A and a second pipe 20B with respective flanges 22A and 22B. Each of the flanges 22A and 22B is connected to its respective pipe 20A and 20B by welding or another sealed arrangement. To assemble the flange-to-flange pipe arrangement 10, a gasket 24 is positioned between the flanges 22A and 22B, and then the flanges 22A and 22B are pressed together (e.g., using nuts 26 and bolts 28).

FIG. 2 is a cutaway diagram of an illustrative welding neck flange 22 to which a non-invasive flange inspection technique 100 can be applied. The dimensional characteristics of the welding neck flange 22 include a neck diameter (D_{PJ}), a bolt-to-bolt diameter (D_{BTB}), a total flange diameter (D_{F}), a bolt hole diameter (D_{B}), a flange rim height (H_{R}), a total flange height (H_{F}), and a raised surface length (L_{RS}). For the welding neck flange 22 of FIG. 2, the raised surface is the hidden gasket sealing surface 30 once assembly of a flange-to-flange pipe arrangement 10 is complete. The welding neck flange 22 is only one type of flange to which the non-invasive flange inspection technique 100 can be applied. Without limitation, other flange types include slip-on flanges, socket weld flanges, lap joint flanges, threaded flanges, and blind flanges. The hidden gasket sealing surface 30 of a flange can be a raised surface as shown, a flat surface, or a more complex surface. When a flange-to-flange pipe arrangement 10 is assembled the hidden gasket sealing surfaces 30 of two flanges contact a gasket and provide a seal such that fluids (liquid or gas) inside an assembled pipe do no leak out even under high pressure. Over time, the condition of a flange and/or a gasket can degenerate, especially when the fluids inside the piping are corrosive. Accordingly, refineries often have a piping/flange inspection and maintenance routine to ensure safety.

FIG. 3 is a block diagram of an illustrative non-invasive flange inspection environment 40. The environment 40 may represent a refinery or other facility that employs a plurality of assembled flange-to-flange pipe arrangements 10A-10N. To inspect the condition of a flange's hidden gasket sealing surface 30, a non-invasive flange inspection technique 100 is applied, as described herein, such that disassembly of the flange-to-flange pipe arrangements 10A-10N is avoided unless the results of the non-invasive flange inspection technique 100 are inconclusive or otherwise indicate that further inspection is needed.

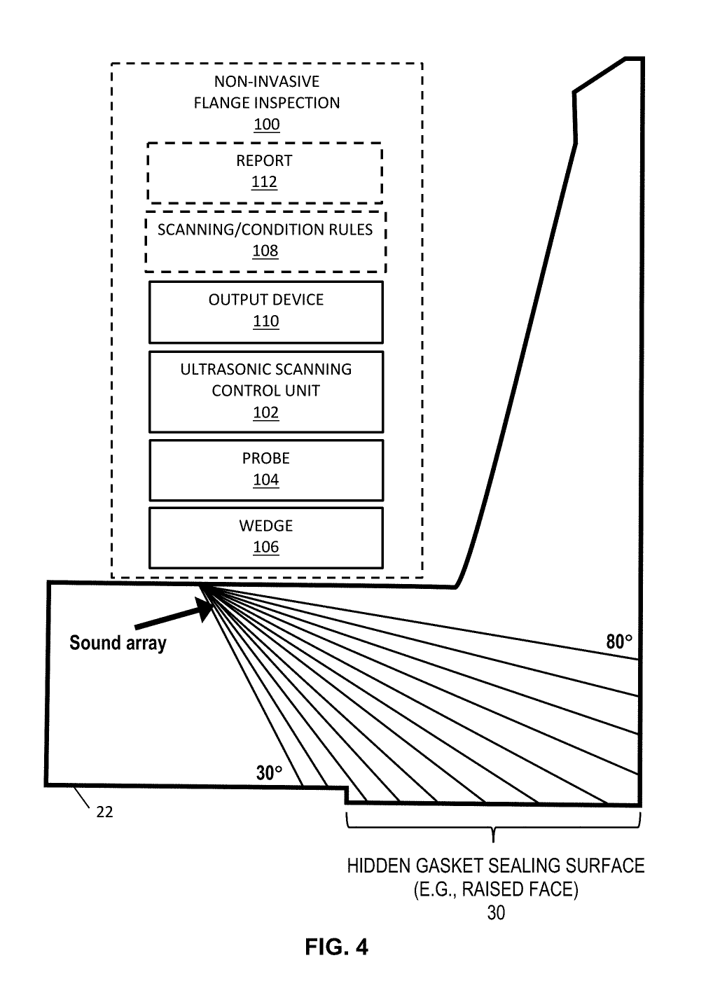

FIG. 4 is a block diagram and partial cross-sectional view of a non-invasive flange inspection scenario. In FIG. 4, the non-invasive flange inspection technique 100 involves using an ultrasonic scanning control unit 102 and a probe 104 to scan the hidden gasket sealing surface 30 of a flange 22. In operation, the ultrasonic scanning control unit 102 outputs control signals to the acoustic transducers of the probe 104 resulting in different ultrasonic scanning options. In at least some embodiments, a wedge 106 can be positioned between the probe 104 and the flange 22 to further vary the ultrasonic scanning options available. With proper programming of the ultrasonic scanning control unit 102, selection/adjustment of options for the probe 104 (e.g., probe type and orientation), and/or selection/adjustment of options for the wedge 106 (e.g., wedge type and orientation), ultrasonic scanning results can be obtained for multiple radial distances along a hidden gasket sealing surface 30 of the flange 22. In FIG. 4, six radial measurement points (corresponding to signals of a sound array at angles from around 40° to 60° relative to the probe 104 or sound array source) are represented along the cross-sectional view of the hidden gasket sealing surface 30.

As desired, ultrasonic scanning can be performed for the flange 22 such that ultrasonic scanning results corresponding to multiple radial distances and/or multiple azimuthal angles of the hidden gasket sealing surface 30 are obtained. In this manner, the condition of the entire hidden gasket sealing surface 30 of the flange 22 can be accurately revealed. It should be understood that the number of ultrasonic scanning results used to identify the condition of the hidden gasket sealing surface 30 can vary for different embodiments (i.e., the resolution of measurement points across the hidden gasket sealing surface can be increased or decreased). Such variations in condition identification are included in a set of scanning/condition rules 108, which can be updated as needed to account for variations in different ultrasonic scanning control units 102, different ultrasonic scanning control unit programming options, different probes 104, different wedges 106, different types of flanges 22, different types of flange-to-flange arrangements, different customer requests, laboratory tests, trial-and-error results, etc.

In at least some embodiments, the scanning/condition rules 108 include rules regarding how to interpret ultrasonic scanning results for a particular ultrasonic scanning control unit 102 with a given programming, probe 104, and/or wedge 106 to identify a level of tapering and/or corrosion along a hidden gasket sealing surface 30. As an example, ultrasonic scanning results may be displayed to an operator, who is able to apply scanning/condition rules 108 manually (or by interacting with graphic user interface) to identify the condition of the hidden gasket sealing surface 30. As another option, the data corresponding to ultrasonic scanning results can be analyzed by a computer based on a predetermined set of rules (e.g., image analysis rules) to identify the condition of the hidden gasket sealing surface 30. Even if a computer is employed to perform condition analysis on obtained ultrasonic scanning results, an operator of the ultrasonic scanning control unit 102 may still view ultrasonic scanning results (e.g., via the output device 110) to ensure the captured ultrasonic scanning results include a threshold level of meaningful data. In some embodiments, identifying the condition of a flange's hidden gasket sealing surface 30 may be performed in real-time once ultrasonic scanning results are obtained. Additionally or alternatively, identifying the condition of a flange's hidden gasket sealing surface 30 may be performed or re-verified after the ultrasonic scanning results are obtained and stored for later analysis. In different embodiments, the output device 110 represents a tablet, a touchscreen, a computer monitor, a printer, a computer, a computer-readable storage medium, and/or a combination of such components, whereby ultrasonic scanning results are reviewed manually or programmatically (e.g., using a computer and one or more programs) based on the scanning/condition rules 108 to identify the condition of a flange's hidden gasket sealing surface 30. The scanning/condition rules 108 may include thresholds related to different levels (e.g., good/bad, a score of 1-5, a score 1-10, etc.) of tapering and/or corrosion. Such thresholds can be used to manually or programmatically (e.g., using a computer) provide a report 112 to a customer regarding the condition of one or more flanges 22 based on the non-invasive inspection technique 100 described herein.

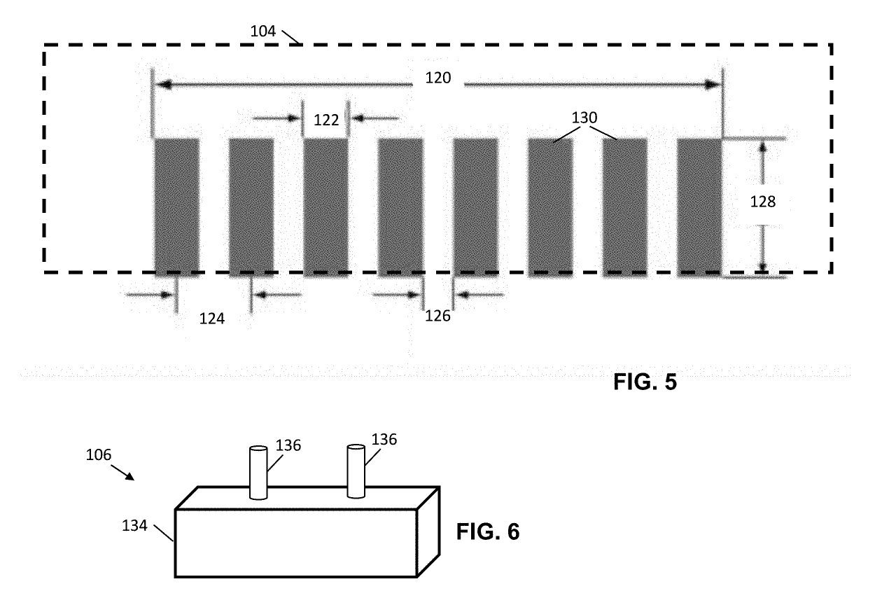

FIG. 5 is a block diagram of an illustrative ultrasonic probe 104. As shown, the ultrasonic probe 104 of FIG. 5 includes a plurality of transducer elements 130 that generate sonic waves individually and/or in different combinations or sequences according to control signals received from an ultrasonic scanning control unit 102. Different ultrasonic probes may vary with regard to the number of transducer elements 130, the transducer element width 122, the transducer element height 128, the spacing 126 between adjacent transducers 130, the center-to-center spacing 124 between adjacent transducers 130, and the total transducer array width 120.

FIG. 6 is a block diagram of an illustrative wedge 106 for use with an ultrasonic probe 104. The wedge 106 of FIG. 6 includes a base material 134 and connectors 136. The base material 134 may be, for example, Rexolite or Plexiglas. Meanwhile, the connectors 134 may be metal inserts that extend into the base material 134 and also provide a connection point for a probe 104. In different embodiments, the shape, size, and composition of the base material 134 for a wedge 306 may vary. Further, in different embodiments, the quantity, composition, shape, arrangement, and size of the connectors 136 for a wedge 306 may vary.

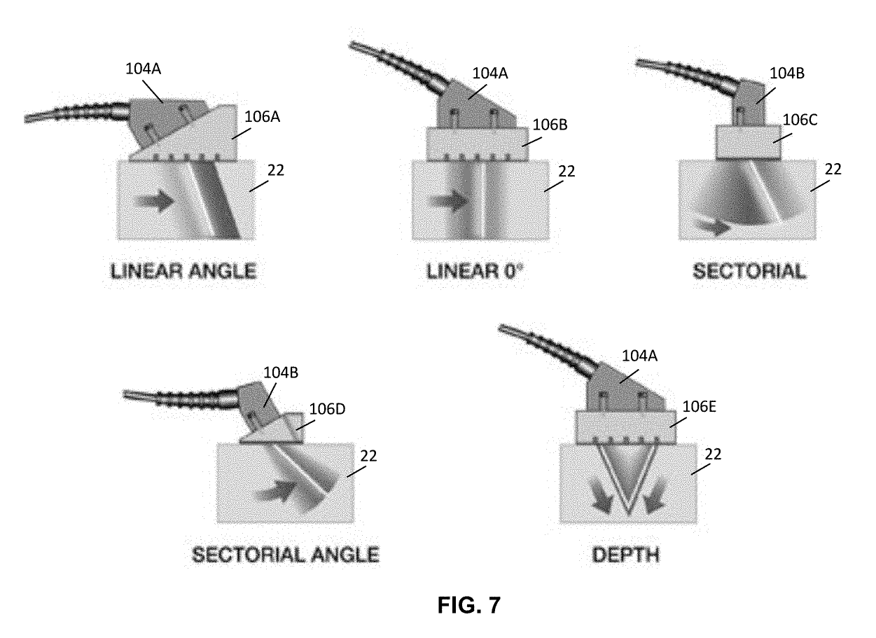

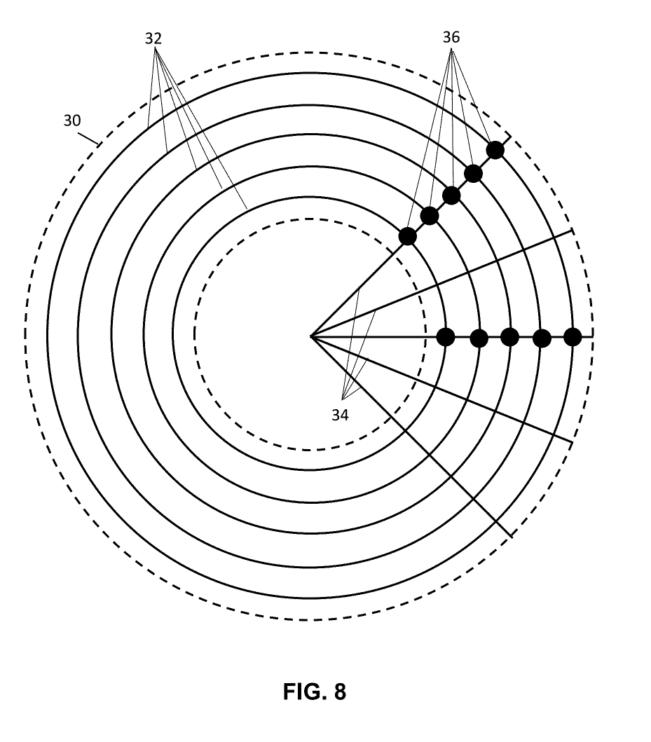

FIG. 7 shows a perspective view of different ultrasonic scanning scenarios. In FIG. 7, different combinations of ultrasonic scanning probes 104A, 104B and wedges 106A-106E are represented. The different combinations of ultrasonic scanning probes 104A, 104B and wedges 106A-106E provide different scanning options (e.g., linear angle, liner 0°, sectorial, sectorial angle, and depth) in accordance with programmed output control signals from an ultrasonic scanning control unit 102.

FIG. 8 shows a hidden gasket sealing surface 30 and illustrative measurement points 36 as a function of radial distance 32 and azimuthal angle 34. In FIG. 8, the shape of the hidden gasket sealing surface 30 is shown using dotted lines (a circular shape with a hole in the middle). The shape of the hidden gasket sealing surface 30 will usually match the shape of a gasket for a flange-to-flange pipe arrangement. The solid line circles of FIG. 8 represent different radial distances 32 along the surface of the hidden gasket sealing surface 30. Meanwhile, the solid lines extending from the center correspond to different azimuthal angles 34 that extend through the hidden gasket sealing surface 30. In different embodiments, the number of measurement points around a hidden gasket sealing surface 30 obtained using the non-invasive flange inspection technique 100 described herein may vary (e.g., by varying the quantity and/or the spacing of azimuthal angles 34 and radial distances 32 at which measurements along the hidden gasket sealing surface 30 are obtained). Such variations can be controlled by manually manipulating the probe/wedge angle, by using different probes 104 and/or wedges 106, and/or by programming different ultrasonic scanning options (see e.g., FIG. 7).

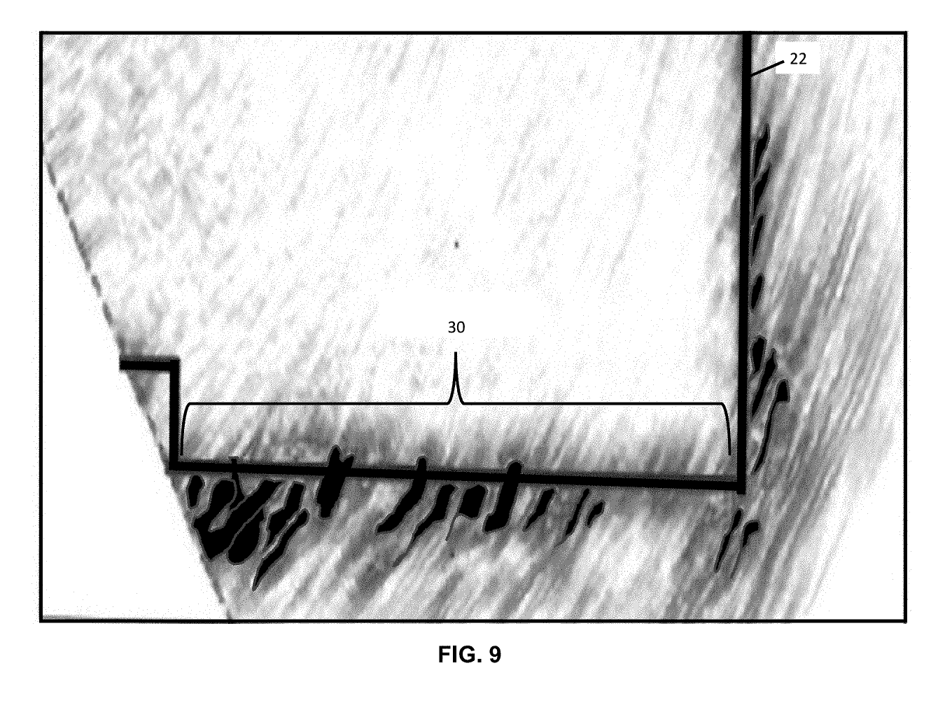

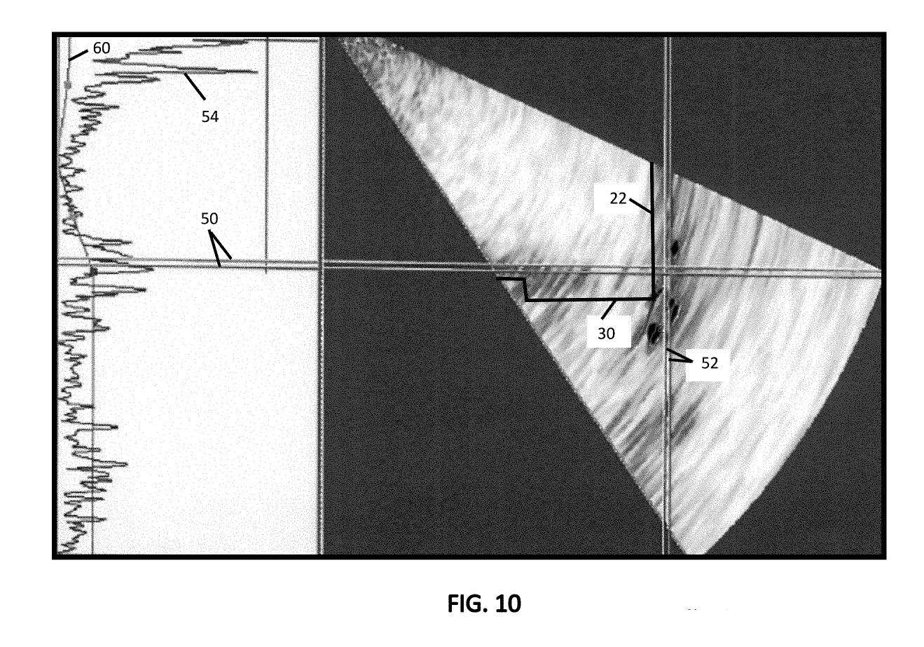

FIG. 9 shows an illustrative image corresponding to ultrasonic scanning results obtained to inspect a hidden gasket sealing surface 30 of a flange 22. In FIG. 9, the image is an S-scan or sectorial scan image representing a two-dimensional cross-sectional view derived from a series of A-scans that have been plotted with respect to time delay and refracted angle. To produce such an image, an ultrasonic scanning control unit 102, probe 104, and/or wedge 106 provide sound beam sweeps through a series of angles.

FIG. 10 shows another illustrative image of ultrasonic scanning results related to inspection of a hidden gasket sealing surface 30 of a flange 22. In FIG. 10, the right side shows an S-scan image representing a two-dimensional cross-sectional view derived from a series of A-scans that have been plotted with respect to time delay and refracted angle. Meanwhile, the left side of FIG. 10 shows one of the A-scans. Different A-scans can be viewed, for example, by moving cursor lines 50, 52 over different areas of the S-scan, where each A-scan is a simple RF waveform presentation showing the time and amplitude of a corresponding ultrasonic signal 54. By analysis of the S-scan and/or related A-scans, an analyst or computer program can identify the condition of the flange 22. In particular, tapering and/or corrosion along the hidden gasket sealing surface 30 are issues that can affect the seal provided by flanges 22 and a gasket 24 in a flange-to-flange arrangement. Accordingly, the non-invasive flange inspection technique 100 targets identification of any tapering and/or corrosion along the hidden gasket sealing surface 30.

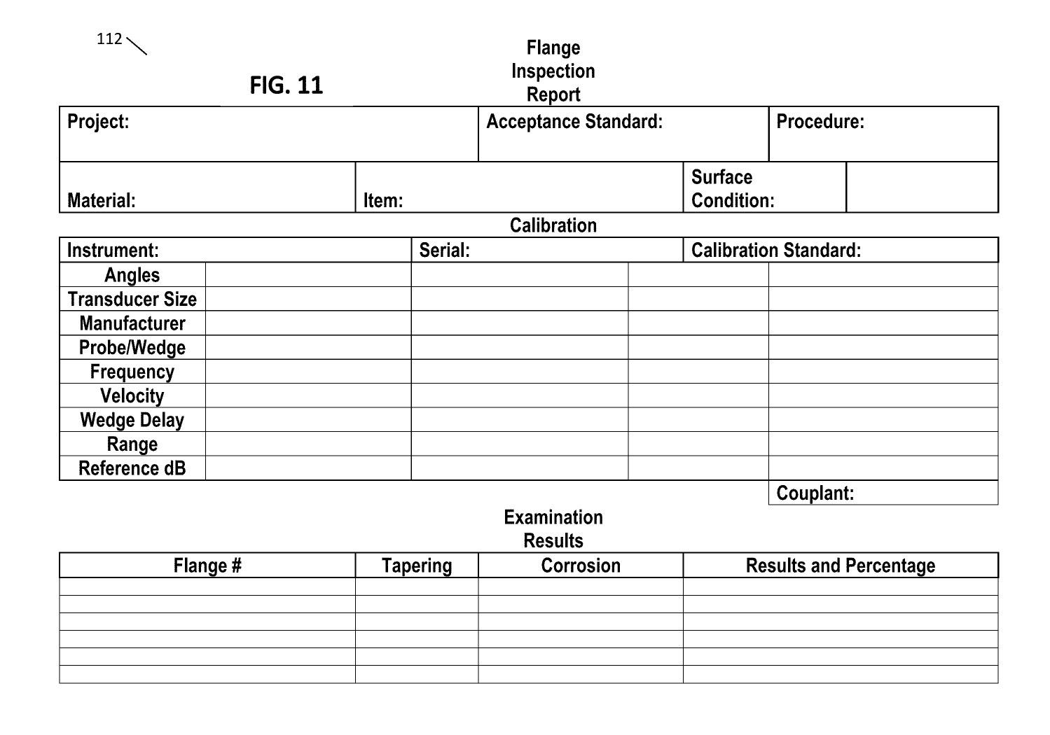

FIG. 11 shows an illustrative flange inspection report 112. As shown in FIG. 11, the report 112 may include various details related to a particular project, the equipment used, the calibration of relevant equipment, and ultrasonic scanning details. For example, the ultrasonic scanning instrument used may be Olympus Omniscan MX2 device and the calibration standard may be ASME BCB CS 1″ C-35. Also, an example couplant is a Sonotech Ultra Gel II.

The report 112 includes a list of flanges inspected and the relevant details of any tapering and/or corrosion. The report 112 is provided to a customer as an electronic file and/or as a hardcopy document for use in making decisions regarding subsequent maintenance, replacement, and/or inspection of flanges. While only a few flanges are represented in the report 112 of FIG. 11, it should be understood that different facilities will have hundreds or thousands of flanges to be inspected and corresponding reports 112 will reflect the size of a particular project.

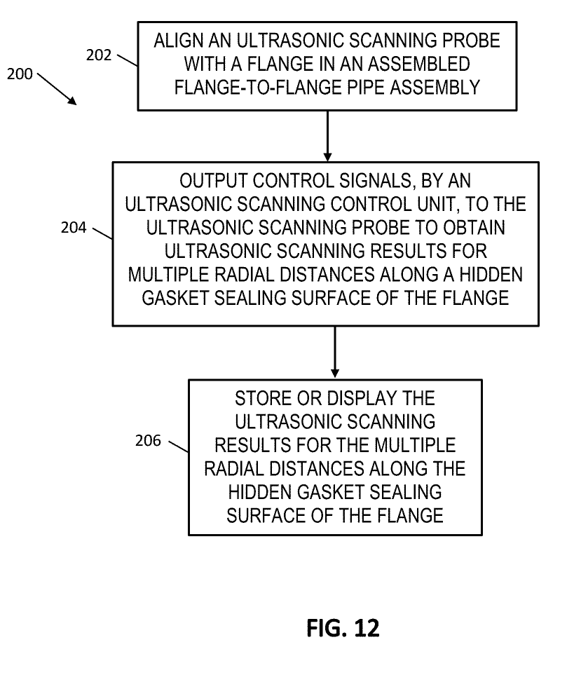

FIG. 12 shows a flowchart of an illustrative non-invasive flange inspection method 200. In method 200, an ultrasonic scanning probe (e.g., probe 104) is aligned with a flange in an assembled flange-to-flange pipe arrangement (see e.g., FIGS. 3 and 4) at block 202. At block 204, output control signals are provided, by an ultrasonic scanning control unit (e.g., unit 102), to the ultrasonic probe to obtain ultrasonic scanning results for multiple radial distances along a hidden gasket sealing surface (e.g., surface 30) of the flange (e.g., flange 22). At block 206, the ultrasonic scanning results are stored or displayed for the multiple radial distances along the hidden gasket sealing surface. In different embodiments, the method 200 also may includes positioning a wedge (e.g., wedge 106) between the probe and the flange. Additionally or alternatively, the angle of the probe or wedge relative to the hidden gasket sealing surface of the flange may be adjusted. Additionally or alternatively, beam steering can be used to obtain ultrasonic scanning results for multiple radial distances along the hidden gasket sealing surface without moving the probe and/or the wedge. Such beam steering is accomplished, for example, by programming the ultrasonic scanning control unit and/or by selection of appropriate probes or wedges. The method 200 can be repeated as needed to obtain ultrasonic scanning results corresponding to different azimuths and radial distances along the hidden gasket sealing surface of a flange. In this manner, the entire face of the hidden gasket sealing surface can be inspected. Also, the method 200 can be repeated as needed to inspect a plurality of flanges with hidden gasket sealing surfaces (e.g., flanges in a refinery or other facility). In at least some embodiments, the method 200 involves use of a portable phased-array tool that includes the ultrasonic scanning control unit 102, a probe 104 and an optional wedge 106. For example, the Olympus Omniscan MX2 unit and compatible components can be used. The analysis of ultrasonic scanning results can be manual and/or automated as described herein. In either case, a set of rules can be used to identify the condition of a hidden gasket sealing surface from the ultrasonic scanning results available. Also, a computer with an inspection report program may be used to create an inspection report for any flanges inspected. The information in the inspection report can be entered manually or it can be generated in an automated manner (e.g., by using a program to analyze ultrasonic scanning results relative to an index of flanges and then assign analysis results to each indexed flange).

These and numerous other modifications, equivalents, and alternatives, will become apparent to those skilled in the art once the above disclosure is fully appreciated. For example, the non-invasive flange inspection technique 100 described herein can be applied to other flange arrangements or other components with a hidden gasket sealing surface (the technique 100 is not limited to assembled flange-to-flange pipe arrangements). It is intended that the following claims be interpreted to embrace all such modifications, equivalents, and alternatives where applicable.

What is claimed is:

1. A non-invasive flange inspection system that comprises:
an ultrasonic scanning control unit;
a probe with acoustic transducers coupled to the ultrasonic scanning control unit;
an output device that stores or displays ultrasonic scanning results, obtained using the ultrasonic scanning control unit and the probe on a flange in an assembled flange-to-flange pipe arrangement, for multiple radial distances along a hidden gasket sealing surface of the flange.

2. The system of claim 1, further comprising a wedge positioned between the probe and the flange while collecting said ultrasonic scanning results.

3. The system of claim 1, wherein the probe is a 10 MHz probe.

4. The system of claim 1, wherein the ultrasonic scanning control unit is programmed to perform beam steering at a plurality of angles without moving the probe to obtain the ultrasonic scanning results for multiple radial distances along the hidden gasket sealing surface of the flange.

5. The system of claim 1, wherein the probe angle relative to the hidden gasket sealing surface of the flange is adjusted manually to obtain the ultrasonic scanning results for multiple radial distances along the hidden gasket sealing surface of the flange.

6. The system of claim 1, wherein the ultrasonic scanning control unit, the probe, and the output device are part of a portable phased-array tool.

7. The system of claim 1, wherein the ultrasonic scanning results correspond to S-scans and related A-scans, wherein the S-scans and related A-scans are analyzed to identify a level of corrosion or tapering at different radial distances along a hidden gasket sealing surface of the flange.

8. The system of claim 7, wherein a user manually analyzes displayed S-scans and related A-scans to identify a level of corrosion or tapering at different radial distances along the hidden gasket sealing surface of the flange.

9. The system of claim 7, wherein a computer executes a program to automate analysis of the S-scans and related A-scans to identify a level of corrosion or tapering at different radial distances along the hidden gasket sealing surface of the flange.

10. The system of claim 1, further comprising a computer with a processor and a computer-readable storage medium that stores an inspection report program, wherein the inspection report program, when executed, is used to create an inspection report for the flange based on the ultrasonic scanning results for multiple radial distances along the hidden gasket sealing surface of the flange.

11. A non-invasive flange inspection method that comprises:
aligning an ultrasonic scanning probe with a flange in an assembled flange-to-flange pipe arrangement;
outputting control signals, by an ultrasonic scanning control unit, to the ultrasonic scanning probe to obtain ultrasonic scanning results for multiple radial distances along a hidden gasket sealing surface of the flange; and
storing or displaying the ultrasonic scanning results for the multiple radial distances along the hidden gasket sealing surface of the flange.

12. The method of claim 11, wherein said aligning comprises positioning a wedge between the probe and the flange.

13. The method of claim 11, wherein the ultrasonic scanning results for multiple radial distances along the hidden gasket sealing surface of the flange are obtained by adjusting an angle of the probe relative to the hidden gasket sealing surface of the flange.

14. The method of claim 11, wherein the ultrasonic scan results for multiple radial distances along the hidden gasket sealing surface of the flange are obtained using beam steering without moving the probe.

15. The method of claim 14, further comprising programming the ultrasonic scanning control unit to perform the beam steering at a plurality of angles relative to the hidden gasket sealing surface of the flange.

16. The method of claim 11, wherein outputting control signals comprises directing transducers of a 10 MHz probe.

17. The method of claim 11, further comprising performing said aligning, said outputting, and said storing or displaying for different areas around the flange to obtain a set of inspection points at different azimuths and radial distances along the hidden gasket sealing surface of the flange.

18. The method of claim 17, further comprising analyzing S-scans and related A-scans, corresponding to the ultrasonic scanning results, to identify a level of corrosion or tapering at different radial distances along the hidden gasket sealing surface of the flange.

19. The method of claim 11, further comprising using a portable phased-array tool to perform said outputting and said storing or displaying.

20. The method of claim 11, further comprising using a computer with an inspection report program to create an inspection report for the flange based on the ultrasonic scanning results for multiple radial distances along the hidden gasket sealing surface of the flange.
